(19) United States
(12) Patent Application Publication
(10) Pub. No.: US 2003/0085861 A1
(43) Pub. Date: May 8, 2003

(54) Gray scale driving method of liquid crystal display panel

(76) Inventor: Masafumi Hoshino, Chiba-shi (JP)

Correspondence Address: ADAMS & WILKS, 31st Floor, 50 Broadway, New York, NY, 10004, US

(21) Appl. No.: 10/273,276

(22) Filed: Oct. 17, 2002

(30) Foreign Application Priority Data
Oct. 18, 2001 (JP) 2001-320668

(51) Int. Cl. G09G 3/36

(52) U.S. Cl. 345/89

(57) ABSTRACT

To reduce the power consumption of a simple matrix liquid crystal panel, by suppressing the number of changes in column electrode waveform without degrading display quality even when the number of gray scales is increased.

In a liquid crystal display panel driving method for a simple matrix liquid crystal display panel in which a liquid crystal layer is held between a row electrode group and a column electrode group to arrange pixels in matrix in accordance with a given pixel data and in which multi gray scale display is performed, pulse width modulation is performed with the sum total of plural pulses selected in plural frames, and the number of changes in column electrode waveform for displaying a half tone pixel data on one pixel is set as 1 during the plural frames.

### BACKGROUND OF THE INVENTION

1. Field of the Invention

The present invention relates to a method of driving a simple matrix liquid crystal display panel that employs an STN liquid crystal or the like, and more particularly to a driving method for a liquid crystal display panel which requires low power consumption and which is suitable for half tone display using frame modulation and pulse width modulation.

2. Description of the Prior Art

A simple matrix liquid crystal display panel is constructed by holding a liquid crystal layer between a row electrode group and a column electrode group to provide pixels arranged in matrix. As a method of driving the simple matrix liquid crystal display panel, there are exemplified a voltage averaging method, an SA method, an MLA method, and the like.

The voltage averaging method is a method of driving a liquid crystal display panel, in which the respective row electrodes are sequentially selected one by one and a data signal corresponding to ON/OFF is provided to all the column electrodes in response to a selected timing. Thus, a voltage applied to each pixel becomes an applied voltage, which is high by one time per frame period T for which all the row electrodes are selected and becomes a predetermined bias voltage during a remaining non-selection time. According to the voltage averaging method, when a response speed of a liquid crystal material to be used is low, a change in brightness corresponding to an effective value of an applied voltage waveform during one frame period is obtained so that a suitable contrast is kept in practical use. However, when the number of divisions is increased, thereby being reduced in a frame frequency, a difference between one frame period and a response time of a liquid crystal becomes small, with the result that the liquid crystal provides a response every time a pulse is applied thereto. Accordingly, a brightness flicker, which is called a frame response phenomenon, is caused, resulting in degradation in a contrast.

The SA method is a method called a smart addressing method. In either of the voltage averaging method and the SA method, the respective row electrodes are sequentially selected one by one, and a data signal corresponding to ON/OFF is applied to all the column electrodes in response to selected timing. However, non-selection levels of common in adjacent frames are different from each other in the former and are identical in the latter.

The MLA method is also called a plural line simultaneous selection method. By simultaneously selecting a plurality of row electrodes, thereby increasing an apparent frequency and suppressing a frame response phenomenon which causes a problem in the voltage averaging method. In order to independently display each pixel while the plurality of row electrodes are simultaneously selected, a unique idea is employed for the MLA method. According to the idea, a set sequential scanning for applying a plurality of row signals represented by a set of orthogonal functions to a row electrode group in set sequence at every selection time, and a sum-of-products calculation between the set of orthogonal functions and a selected pixel data is sequentially conducted, and a column signal having a voltage level corresponding to the result is applied to a column electrode group during the selection time in synchronization with the set sequential scanning.

Note that the MLA method is disclosed in JP 05-100642 A, JP 06-027907 A, JP 07-072454 A, JP 07-193679 A, JP 07-199863 A, JP 07-311564 A, JP 08-184807 A, JP 08-184808, JP 2000-019482, and the like.

Next, a multi gray scale display method of the simple matrix liquid crystal display panel generally includes a pulse width modulation method and a frame modulation method. In the pulse width modulation method, a waveform of a column electrode waveform is switched from ON to OFF in accordance with gray scale information within a period of a selected pulse, with the result that a frequency rises and the power consumption increases. The frame modulation method is technically established as a low-cost method. The frame modulation method is a method of selectively turning ON/OFF two gray scales of ON/OFF over a plurality of frames so that a time average value is utilized to provide two or more gray scales. Half tone display of the simple matrix liquid crystal display panel is realized by a combination of a driving method and a multi gray scale display method.

Here, examination is made on the power consumption of the simple matrix liquid crystal display panel in the case where the pulse width modulation method is used for the multi gray scale display method and it is driven by the voltage averaging method or the SA method. Assume that the simple matrix liquid crystal display panel has a matrix of N-rows and M-columns.

FIG. 2 shows a column electrode waveform by the pulse width modulation, which is applied to the simple matrix liquid crystal display panel, by using a waveform region with oblique lines. In a middle gray scale level, there are an ON period and an OFF period within one selection time, and a round trip is necessarily made during one selection time. Thus, the column electrode waveform is changed two times. Accordingly, the number of changes in column electrode waveform per frame is 2N.

Then, examination will be made on the power consumption of the simple matrix liquid crystal display panel as in the case where the frame modulation method is employed for the multi gray scale display method, and it is driven by the voltage averaging method or the SA method. Note that the frame modulation method is conducted for every row or every pixel.

FIG. 3 shows an example of a 5-gray-scale frame modulation pattern which is applied to a simple matrix liquid crystal display panel. In FIG. 3, when a gray scale level is 0, with respect to a first frame to a fourth frame, all values at intersections between the rows and the columns in the simple matrix liquid crystal display panel are indicated by 0 (OFF).

When a gray scale level is 1, 1 (ON) is provided to a pixel at an intersection between a (2n+1)th row and an odd column of the first frame of the simple matrix liquid crystal display panel; a pixel at an intersection between a (2n+1)th row and an even column of the second frame; a pixel at an intersection between a (2n+2)th row and an odd column of the third frame; and a pixel at an intersection between a (2n+2)th row and an even column of the fourth frame; and 0 (OFF) is provided to other pixels. In this case, n is an integer from 0 to N/2. Thus, the (2n+1)th row indicates an odd row and the (2n+2)th row indicates an adjacent even row.

When a gray scale level is 2, 1 (ON) is provided to a pixel at an intersection between the (2n+1)th row and the odd column of the first frame of the simple matrix liquid crystal display panel; a pixel at an intersection between the (2n+2)th row and an even column of the first frame; a pixel at an intersection between the (2n+1)th row and the even column of the second frame; a pixel at an intersection between the (2n+1)th row and the odd column of the third frame; the (2n+2)th row and an even column of the third frame; a pixel at an intersection between the (2n+1)th row and an odd column of the fourth frame; and a pixel at an intersection between the (2n+2)th row and the even column of the fourth frame; and 0 (OFF) is provided to other pixels.

When a gray scale level is 3, 0 (OFF) is provided to a pixel at an intersection between the (2n+1)th row and the odd column of the first frame of the simple matrix liquid crystal display panel; a pixel at an intersection between the (2n+1)th row and the even column of the second frame; a pixel at an intersection between the (2n+2)th row and the odd column of the third frame; and a pixel at an intersection between the (2n+2)th row and the even column of the fourth frame; and 1 (ON) is provided to other pixels.

When a gray scale level is 4,with respect to the first frame to the fourth frame, 1 (ON) is provided to all the pixels at intersections between the rows and the columns in the simple matrix liquid crystal display panel.

First, when the frame modulation method based on the 5-gray-scale frame modulation pattern shown in FIG. 3 is applied to the simple matrix liquid crystal display panel driven by the voltage averaging method or the SA method, to thereby conduct the multi gray scale display, the column electrode waveform in the case where an image region is scanned from the top to bottom becomes a waveform as shown in FIG. 4A or 4B. Note that, for simple description, assume that a displayed data is a data of one half tone color.

In other words, FIG. 4A shows a column electrode waveform in the case where both a pixel at an intersection between a column electrode and the (2n+1)th row electrode and a pixel at an intersection between the column electrode and the (2n+2)th row electrode are ON or OFF in the 5-gray-scale frame modulation pattern shown in FIG. 3, by using a waveform region with oblique lines. The level of the column electrode waveform in this case is +1/πN during a selection time t of one frame period T and −1/πN during a remaining non-selection time (T−t). In a next frame, the level is inverted and the similar column electrode waveform is indicated. Thus, when both upper and lower rows are turned ON or OFF in a middle gray scale level, the number of changes in column electrode waveform during one frame period is 1.

Also, FIG. 4B shows a column electrode waveform in the case where one of a pixel at an intersection between a column electrode and the (2n+1)th row electrode and a pixel at an intersection between the column electrode and the (2n+2)th row electrode is ON and the other is OFF in the 5-gray-scale frame modulation pattern shown in FIG. 3, by using a waveform region with oblique lines. The level of the column electrode waveform in this case is +1/πN during the selection time t of one frame period T. With respect to the remaining non-selection time (T−t), a level is −1/πN during a first t and +1/πN during a next t. Hereinafter, a level is similarly changed up to a final t. In a next frame, the level is inverted and a column electrode waveform in which −1/πN and +1/πN are similarly repeated is indicated. Thus, when rows are turned ON or OFF every two rows in the middle gray scale level, the number of changes in column electrode waveform during one frame period is N, which is equal to the number of row electrodes.

Incidentally, the power consumption of the liquid crystal panel is determined by a free discharge current between the row electrode and the column electrode. In other words, the power consumption of the liquid crystal panel is determined by a voltage value and its waveform (the amount of change) between the row electrode and the column electrode.

Therefore, in the simple matrix liquid crystal panel for performing multi gray scale display, the number of changes in column electrode waveform in the pulse width modulation method becomes larger than that in the frame modulation method, and the power consumption is also increased in proportion to the number of changes. However, in the case of the frame modulation method, the number of frames for representing gray scales is increased with increasing the number of gray scales. Thus, a flicker, roughness, or the like is caused on a screen, thereby deteriorating a display quality.

### SUMMARY OF THE INVENTION

As has been described above, the conventional driving method suffers from a problem that an increase in power consumption and deterioration of display quality due to increased number of gray scales cannot be prevented at the same time. Therefore, an object of the present invention is to provide a method of driving a simple matrix liquid crystal panel, in which the number of changes in column electrode waveform is suppressed without deteriorating a display quality even when the number of gray scales is increased, to thereby reduce the power consumption of the simple matrix liquid crystal panel.

In order to solve the above-mentioned problems, pulse width modulation is performed using the sum total of a plurality of pulses selected in a plurality of frames, and the number of changes in column electrode for displaying a half tone pixel data on a pixel is set as 1 during the plurality of frames. In addition, attention is directed to the fact that a gray scale level of a background color or of a display data mainly used is not frequently and greatly changed, the present invention is constructed.

In other words, in a liquid crystal display panel driving method of driving a liquid crystal display panel in which a liquid crystal layer is held between a row electrode group and a column electrode group to provide pixels in matrix in accordance with a given pixel data, one selection time is equally divided into a plurality of periods to form a column electrode waveform, the process is repeated during periods of several frames, and half tone display is conducted with the sum total of equally divided periods at selection of the respective frames.

Also, a pulse width modulation pattern is divided into a plurality of frames and the appearance order thereof is changed for each of the frames.

Also, a pulse width modulation pattern is divided into a plurality of frames and the appearance order thereof is changed for every one column in the column direction.

### BRIEF DESCRIPTION OF THE DRAWINGS

In the accompanying drawings:

FIG. 1 is a block diagram of a simple matrix liquid crystal display panel driving device constructed by applying a liquid crystal display panel driving method of the present invention thereto;

FIG. 2 shows an example of a column electrode waveform in a pulse width modulation method;

FIG. 3 shows an example of a frame modulation pattern of 5 gray scales;

FIGS. 4A and 4B show examples of waveforms in a conventional drive using a voltage averaging method or an SA method;

FIG. 5 shows a 4-frame pulse pattern modulation pattern;

FIG. 6 shows a waveform in a drive using a voltage averaging method or an SA method according to the present invention;

FIG. 7 shows a waveform in a drive using an MLA method according to the present invention;

FIG. 8 shows an example of an orthogonal function table used in a 4 MLA method;

FIGS. 9A and 9B show another example of the 4-frame pulse width modulation pattern.

### DETAILED DESCRIPTION OF THE PREFERRED EMBODIMENTS

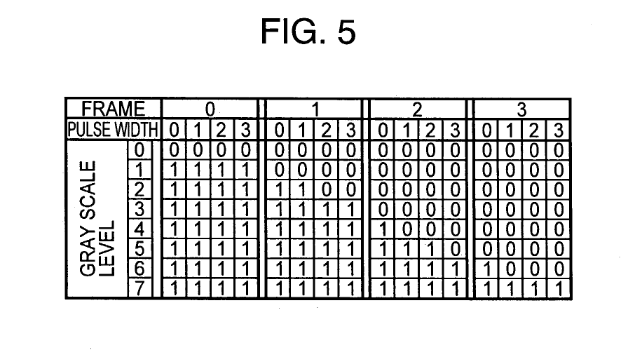

Embodiments of the present invention will be described hereinbelow with reference to the drawings. First, discussion will be made on a case where, in a simple matrix liquid crystal display panel driven by a voltage averaging method or an SA method, one selection time t is divided into four equal parts, and a gray scale data is represented by four frames. FIG. 5 shows an example of a 4-frame pulse width modulation pattern in this case. In FIG. 5, “0” indicates that display data is OFF and “1” indicates that display data is ON. In this example, four equal parts obtained by dividing selection time t of each frame are set as pulse widths 0-3. For example, when the gray scale level is 2, in frame 0 display data become ON in all of the pulse widths 0-3 within the selection time t, while in frame 1 display data become ON during half the selection time, that is, in pulse widths 0 and 1, and OFF in pulse widths 3 and 4. Further, display data become OFF during the entire selection time in frames 2 and 3.

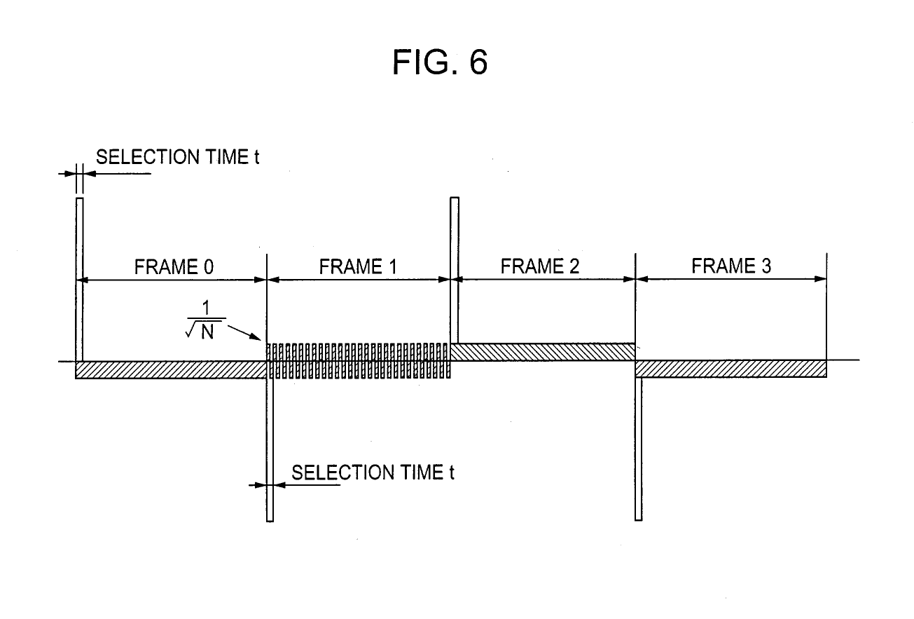

Here, for simplicity of description, it is assumed that the data to be displayed is displayed in half tone level 2 on the entire screen. FIG. 6 shows a column electrode waveform in the case where the 4-frame pulse width modulation pattern of FIG. 5 is used. In half tone level 2, as regards the column electrode, only in frame 1 a round trip is performed within the selection time t so that its waveform changes twice. In all the other frames, display data become ON or OFF throughout the entire selection time so that there occurs no change in the column electrode. Further, as shown in FIG. 6, in frame 1 the column electrode waveform similarly changes in non-selection time as in the selection time t. On the other hand, in all the other frames, display data become ON or OFF during the entire non-selection time so that no change occurs in the column electrode within each of the frames.

Thus, the number of changes in the column electrode is 2N per 4 frames, or N/2 per 1 frame. This is ¼ of the number 2N being the number of changes in the column electrode in the case of pulse width modulation described in the conventional example. Also, the number of frames necessary to represent the gray scales is 4,thus preventing degradation of display quality. For higher gray scale levels, the number of divisions of the selection time t may be increased to avoid an increase in the number of frames necessary to represent the gray scales.

Next, a case is considered in which gray scale data is represented by four frames and one selection time t is divided into four equal parts, on a simple matrix liquid crystal panel driven by a distributed 4 MLA method. As for the width modulation pattern, there is used the 4-frame pulse width modulation pattern shown in FIG. 5 in relation to the voltage averaging method or the SA method.

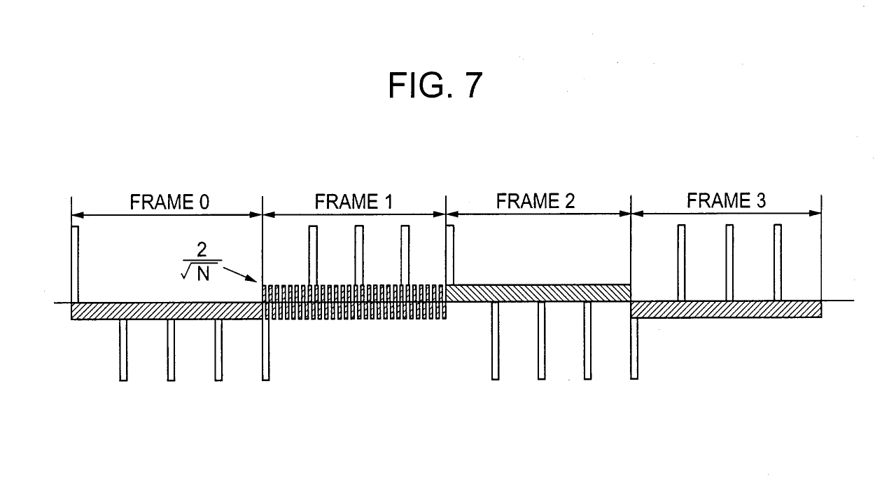

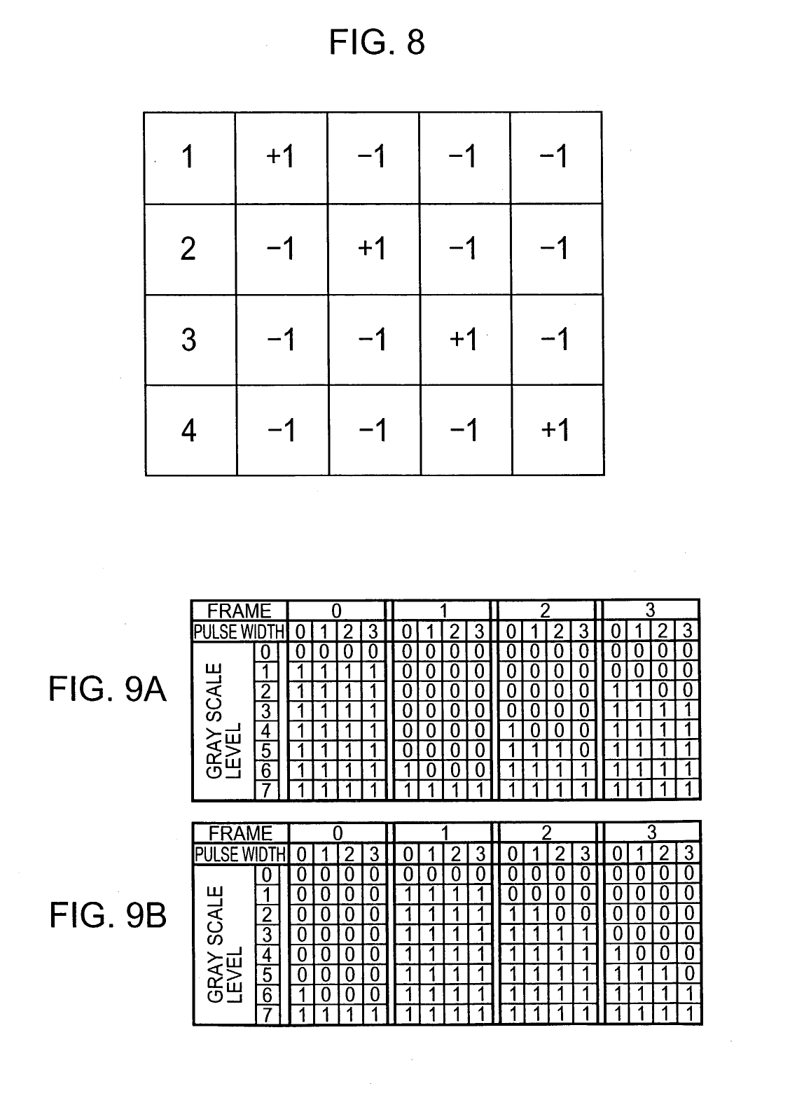

For simplicity of description, it is assumed that the data to be displayed is of half tone level 2 on the entire screen, and a function shown in FIG. 8 is used as the orthogonal function. FIG. 7 shows a column electrode waveform in the case where the 4-frame pulse width modulation pattern shown in FIG. 5 is used. In half tone level 2, with respect to the column electrode, only in frame 1 a round trip is performed within the selection time t so that its waveform changes twice. In all the other frames, display data become ON or OFF during the entire selection time so that there occurs no change in column electrode waveform in each of the frames. Therefore, the same effect as in the case of the aforementioned voltage averaging method or SA method is obtained. Further, as shown in FIG. 7, in frame 1 the column electrode waveform similarly changes in non-selection time as in the selection time t. On the other hand, in all the other frames, display date become ON or OFF during the entire non-selection time so that no change occurs in the column electrode within each of the frames.

The gist of the present invention resides in that the column electrode waveform changes only one time through a round trip in any gray scale level during several frames required for representing a gray scale. Thus, the present invention is not limited to the driving method, the number of frames required for representing the gray scales, and the number of divisions of the selection time which are described in the embodiment mentioned above.

FIG. 9A shows an example in which the appearance order of plurality of frames is changed. The 4-frame pulse width modulation pattern indicated here is obtained by switching the appearance order of frame 1 and frame 3 of the pattern shown in FIG. 5, so that ON and OFF states will appear in alteration. Thus, a flicker can be reduced.

FIGS. 9A and 9B show an example in which the appearance order of plural frames is changed every one column in the column direction. FIG. 9B shows a case where, in the pattern shown in FIG. 9A, frame 1 and frame 0, and frame 2 and frame 3, are switched for each other within each frame pair. By using the pattern of FIG. 9A for odd columns and that of FIG. 9B for even columns, the brightness of the respective frames become uniform over the entire screen, thereby reducing a flicker.

As has been described above, by employing the 4-frame pulse width modulation pattern shown in FIGS. 9A and 9B, it is possible to increase the number of frames required for representing the gray scales without causing a flicker, thereby further reducing the power consumption.

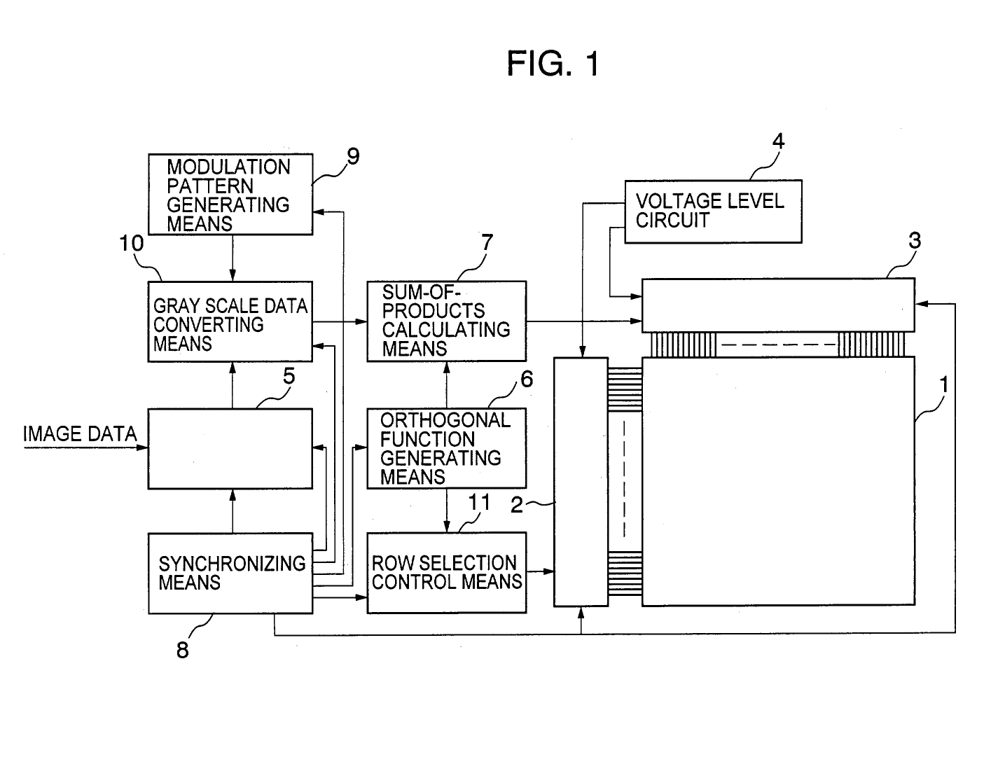

Next, an example of a liquid crystal display panel driving device using the MLA method to which the present invention is applied will be described with reference to FIG. 1. That is, the liquid crystal display panel driving device using the MLA method as shown in FIG. 1 includes a simple matrix liquid crystal display panel 1 of N rows×M columns, a perpendicular driver 2 for applying row voltages to a row electrode group of N rows in the liquid crystal display panel 1, a horizontal driver 3 for applying column voltages to a column electrode group of M columns in the liquid crystal display panel 1, and a voltage level circuit 4 for supplying voltages of necessary levels to the perpendicular driver 2 and the horizontal driver 3.

Also, the liquid crystal display panel driving device using the MLA method as shown in FIG. 1 includes a frame memory 5 for storing an image data composed of plural bits in units of frame, an orthogonal function generating means 6 for generating plural orthogonal functions in which there is an orthogonal relationship among them and providing a pattern obtained by a suitable combination thereof in succession to the perpendicular driver 2 through a row selection control means 11, a modulation pattern generating means 9 for generating a modulation pattern used in row selection, a gray scale data converting means 10 for converting the image data stored in the frame memory 5 into the modulation pattern, and a sum-of-products calculating means 7 for conducting sum-of-products calculation between a set of converted image data and a set of orthogonal functions, generating a column signal corresponding to each bit digit, and providing it to the horizontal driver 3.

The above row selection control means 11 is a means for controlling the perpendicular driver 2 so as to simultaneously select plural row electrodes in accordance with the orthogonal functions. Note that an orthogonal function table used for the liquid crystal display panel driving device using the 4 MLA method is a table as shown in FIG. 8.

Further, the liquid crystal display panel driving device includes a synchronizing means 8 for synchronizing among timings of various operations.

Note that, although not shown, a liquid crystal display panel driving device using a voltage averaging method or an SA method to which the present invention is applied can be easily constructed as in the case of the above-mentioned liquid crystal display panel driving device using the MLA method.

As described above in detail, according to the liquid crystal display panel driving method of the present invention using the plural frames pulse modulation method, display can be made without causing image degradation such as a flicker even in the case of multi gray scale display in which the number of colors exceeds 4096, as compared with the conventional liquid crystal display panel driving method using the frame modulation method.

Also, the number of changes in voltage waveform on the column electrode becomes extremely smaller than that in the pulse width modulation method. With respect to row electrodes, a voltage is high. However, selection is conducted only one time during one frame and a capacity of a connected panel is required for only selected electrodes. In contract to this, with respect to the column electrodes, a voltage is low. However, voltage waveforms on the respective electrodes are changed according to display data. Thus, it is necessary to change potentials on the entire screen. Accordingly, the power consumption becomes extremely smaller than that in the pulse width modulation method.

Note that the display pattern of this embodiment is displayed with the same half tone gray scale level on the entire screen. When another display pattern is displayed, the column electrode waveform is changed only one time through a round trip in any gray scale level during several frames required for representing the gray scale so that it is needless to say that the present invention can be applied thereto as a matter of course.

According to the liquid crystal display panel driving method of the present invention, even when the number of gray scales is increased, the number of changes in column electrode waveform can be suppressed without degrading display quality, thereby reducing the power consumption of the simple matrix liquid crystal panel.

FIG. 1

1 N ROWS×M COLUMNS SIMPLE MATRIX LIQUID CRYSTAL DISPLAY PANEL

2 PERPENDICULAR DRIVER

3 HORIZONTAL DRIVER

4 VOLTAGE LEVEL CIRCUIT

5 FRAME MEMORY

6 ORTHOGONAL FUNCTION GENERATING MEANS

7 SUM-OF-PRODUCTS CALCULATING MEANS

8 SYNCHRONIZING MEANS

9 MODULATION PATTERN GENERATING MEANS

10 GRAY SCALE DATA CONVERTING MEANS

11 ROW SELECTION CONTROL MEANS

IMAGE DATA

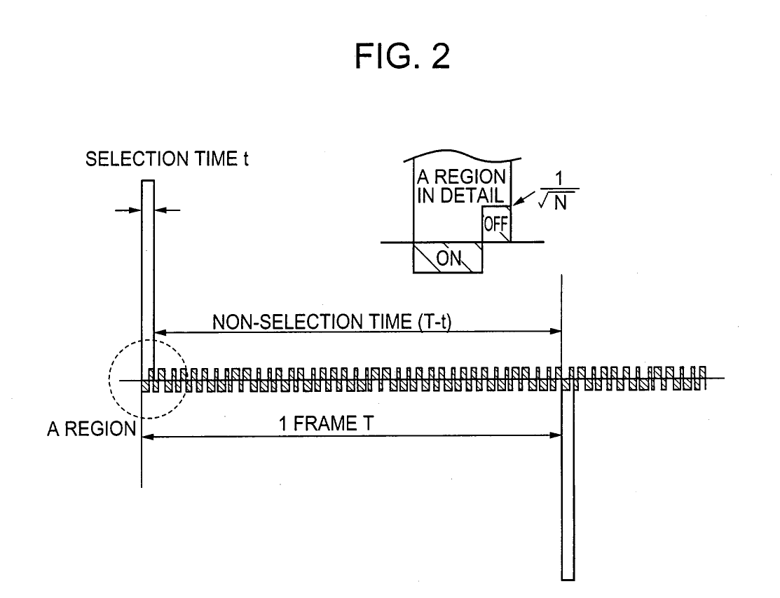

FIG. 2

SELECTION TIME

A REGION

A REGION IN DETAIL

NON-SELECTION TIME

1 FRAME

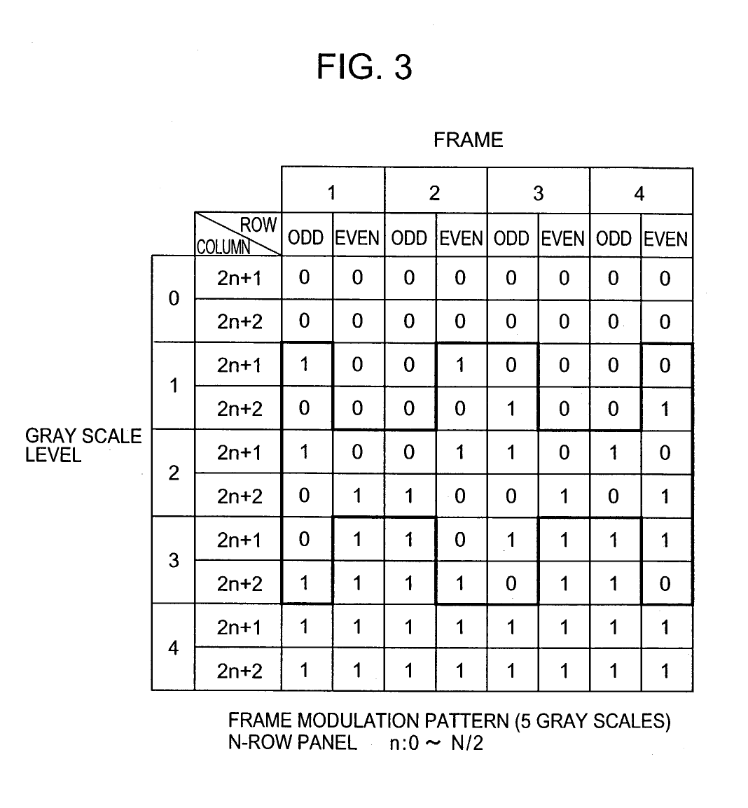

FIG. 3

GRAY SCALE LEVEL

ROW

COLUMN

FRAME

ODD

EVEN

FRAME MODULATION PATTERN (5 GRAY SCALES)

N-ROW PANEL

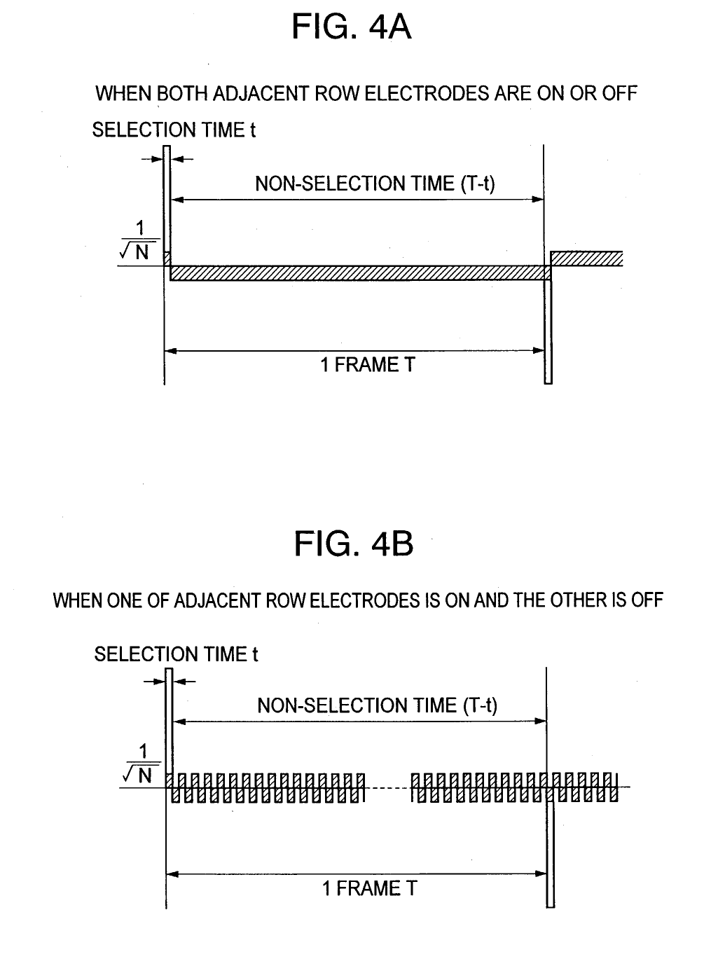

FIG. 4A

WHEN BOTH ADJACENT ROW ELECTRODES ARE ON OR OFF

SELECTION TIME

ONE FRAME

FIG. 4B

WHEN ONE OF ADJACENT ROW ELECTRODES IS ON AND THE OTHER IS OFF

NON-SELECTION TIME

ONE FRAME

FIG. 5

FRAME

PULSE WIDTH

GRAY SCALE LEVEL

FIG. 6

SELECTION TIME

FRAME

FIG. 7

FRAME

FIG. 9

FRAME

PULSE WIDTH

GRAY SCALE LEVEL

What is claimed is:

1. A liquid crystal display panel driving method of driving a liquid crystal display panel in which a liquid crystal layer is held between a row electrode group and a column electrode group to provide pixels in matrix in accordance with a given pixel data, the method comprising performing pulse width modulation with the sum total of a plurality of pulses selected in a plurality of frames.

2. A liquid crystal display panel driving method of driving a liquid crystal display panel in which a liquid crystal layer is held between a row electrode group and a column electrode group to provide pixels in matrix in accordance with a given pixel data, the method comprising performing pulse width modulation with the sum total of a plurality of pulses selected in a plurality of frames,
wherein the number of changes in column electrode waveform for displaying a half tone pixel data on one pixel is set as 1 during the plurality of frames.

3. A liquid crystal display panel driving method of driving a liquid crystal display panel in which a liquid crystal layer is held between a row electrode group and a column electrode group to provide pixels in matrix in accordance with a given pixel data, the method comprising:
dividing a selection time within a frame into a plurality of equal time periods to thereby form a waveform to be applied to a column electrode and repeating the process for several frames; and
performing half tone display with the sum total of the divided equal time periods at selection of the respective frames.

4. A liquid crystal display panel driving method of driving a liquid crystal display panel in which a liquid crystal layer is held between a row electrode group and a column electrode group to provide pixels in matrix in accordance with a given pixel data, the method comprising:
dividing a selection time within a frame into a plurality of equal time periods to thereby form a waveform to be applied to a column electrode; and
applying the waveform repeatedly also in non-selection time within the frame.

5. A liquid crystal display panel driving method according to claim 1, further comprising changing the appearance order of the plurality of frames.

6. A liquid crystal display panel driving method according to claim 1, wherein the appearance order of the plurality of frames is different for each one column.

7. A liquid crystal display panel driving method according to claim 1, wherein the driving method is a voltage averaging method.

8. A liquid crystal display panel driving method according to claim 1, wherein the driving method is an SA method.

9. A liquid crystal display panel driving method according to claim 1, wherein the driving method is an MLA method.
